(19) United States
(12) Patent Application Publication
(10) Pub. No.: US 2016/0228878 A1
(43) Pub. Date: Aug. 11, 2016

(54) Manually Operated Jaw Crusher

(71) Applicant: Clive Graham Smith, Columbia, CA (US)

(72) Inventor: Clive Graham Smith, Columbia, CA (US)

(21) Appl. No.: 14/616,705

(22) Filed: Feb. 8, 2015

(51) Int. Cl. B02C 1/04

(52) U.S. Cl. CPC B02C 1/04

(57) ABSTRACT

A crusher with one stationary jaw and one movable jaw, the movable jaw is moved by a cam at the top of the jaw, in the well known manner of jaw crushers. The cam shaft is adapted to be driven with a conventional square drive lever. A dual purpose bolt, transversely behind and against an upper portion of the stationary jaw, serves as a re-active stop and as a pinch bolt to clamp the stationary jaw between the side plates. The upper ends of the front legs abut a lower portion of the stationary jaw, thereby serving as legs and re-active members for the stationary jaw. A transparent Poly-carbonate feed opening cover is secured to the tops of the side plates with magnets.

### FIELD OF INVENTION

This invention relates to laboratory equipment, assay equipment, small scale ore processing, and arts and crafts.

### BACKGROUND OF INVENTION

Hand operated rock and hard materials crushers fall into the categories of the hammer, the pestle and mortar type and a small jaw crusher. Aside from the well known pestle and mortar, there are several manufactures of steel pipe based designs with manual plunger hammers. These are readily discovered on the Internet.

A jaw type hand operated crusher may be found under the brand name Crazy Crusher, manufactured by Goldquest LLC of Arizona, it is currently commercially available and it claims Patent Pending.

The Crazy Crusher uses two co-operating levers, a lever on each outer side of the crusher and joined at the operated end by a cross bar handle to directly operate the movable jaw. Four corner legs on the Crazy Crusher are vertical, an arrangement which contributes to the crusher having a strong tendency to somersault.

The Crazy Crusher weighs thirty four pounds, has a footprint of six inches by eleven and one half inches, a height of thirteen and one half inches and the overall length is twenty seven inches, in aggregate, a distinct impediment to its portability.

U.S. Pat. No. 4,275,851 titled Ore Sample Crusher, discloses a manual jaw crusher having a handle permanently fixed to the movable jaw. The handle and jaw combination are pivotally mounted to a frame and move to crush material against a fixed anvil plate.

US patent application Publication titled “Manual Pill Crusher”, discloses a pill crusher having a handle permanently fixed to a cam. The cam operates a ram which moves to crush pills against a crushing surface.

U.S. Pat. No. 4,970,917 titled Stud Extractor and Wrench Apparatus, discloses a stud removal tool having a cam system which is operated with a square drive wrench.

U.S. Pat. No. 3,984,058 titled Means for Holding Dies in a Jaw Crusher, discloses a lever wedge system which essentially clamps the stationary die plate in-between the crusher side walls.

U.S. Pat. No. 697,802 titled Ore Crusher, discloses a jaw crusher with two flywheels, and the option of driving them by hand or with a flat belt.

South African Patent 1997/03141 titled Rock Crusher, discloses a large hand operated jaw crusher weighing 240 Kilograms, manufactured by New Dawn Engineering, with the option of one or two flywheels, which are cranked by hand. Transverse pins are used to adjust the upper and lower jaw openings.

### SUMMARY

Accordingly, objects of the present invention include improved portability by minimizing the weight, achieve compactness for portability, economy of design and manufacture and a mechanical advantage with force vectors which reduce the somersaulting tendency and minimize wasted effort.

A cam for driving the movable jaw is adapted to be driven with any readily detachable, conventional square drive lever of the appropriate size, thereby achieving an efficient, compact crusher of reduced weight

The forwardly extended front legs provide reaction to the forwardly tipping forces when work is being done. The upper ends of the front legs abut the lower portion of the stationary jaw, providing a simple and economic combination of legs and reactive members for the stationary jaw, and saving weight.

The stationary jaw is vertical and well secured when the pinch bolt at the top is tightened to clamp the jaw between the side plates. The stationary jaw can be moved up or down when the pinch bolt is slackened; thereby having a simple means of adjusting the gap in-between the bottoms of the jaws; also the pinch bolt provides the upper reactive member; a simple arrangement which further saves weight. When the pinch bolt is slack, the stationary jaw is easily lifted up and out of the crusher, making access for cleaning of both jaws easy.

A transparent poly-carbonate cover for the feed opening provides a way to observe the crushing progress and saves weight by not using a steel cover. Neodymium magnets secure the cover to the tops of the side plates and also serve as hinges; the cover can be hinged up from either side or totally removed.

The current embodiment of this invention has a footprint of five and one half inches by ten and one half inches and it is ten inches high and it weighs only sixteen pounds.

Further objects and advantages of my invention will become apparent from a consideration of the drawings and ensuing description.

### DRAWINGS

FIG. 1 is an isometric view of the crusher. One side plate is ghosted for clarity.

FIG. 2 is an isometric view of the jaws and cam arrangement.

### LIST OF REFERENCE NUMERALS

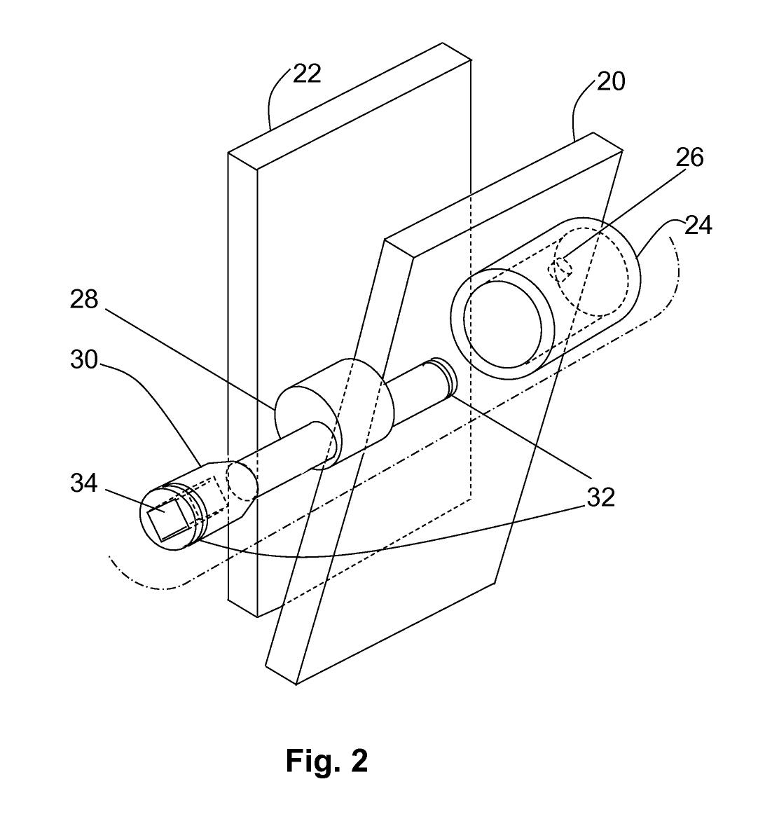

20 Movable Jaw
22 Stationary Jaw
24 Cam Follower
26 Threaded Oiling Hole
28 Cam Lobe (FIG. 2)
30 Cam Shaft
32 Grooves for Retaining Clip (FIG. 2)
34 Cam Shaft Driver Receiver
36 Reactive Stop for Movable Jaw
38 Reactive Stop Pinch Bolt
40 Retaining Clip
42 Side Plates Spacer
43 Nut and Bolt assembly
44 Through bolt and nut assembly for spacer 42
46 Side Plate
48 Retaining Clip
50 Cam Shaft Bushings
52 Rear Leg assembly
53 Rear Foot
55 Front Foot
54 Front Leg assembly
56 Transparent feed opening cover
58 Magnets

### DESCRIPTION OF INVENTION

Referring to FIG. 2; a cam shaft 30 is manufactured from a common square drive extension bar cut to length and retaining the square drive end as the cam shaft driver receiver 34. Grooves for retaining clips 32 are cut on a lathe, one in each end. The cam lobe 28, cut to length from stock, is drilled off centre to snugly receive the cam shaft 30 and the two are assembled in a jig which dictates the proper position of the cam lobe 28 on the cam shaft 30. One side of the square hole which is the cam shaft driver receiver 34 is positioned tangentially to the apex of the cam lobe 28 to ensure that when the cam shaft driving handle is upright, crushing action is available through the first ninety degrees. Each end of the cam lobe 28 is welded to the cam shaft 30.

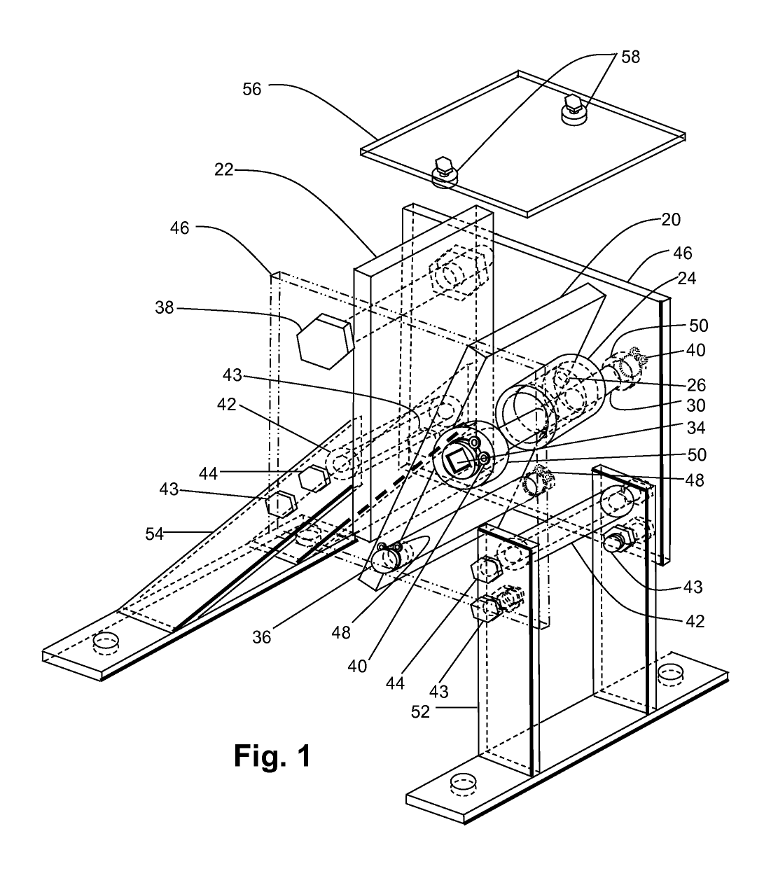

Referring to FIG. 1; the movable jaw 20 and the stationary jaw 22 are equal in size and cut from flat steel stock. A fraction of material is milled from one side of the movable jaw 20 in order to facilitate its free movement when the parallel side plates 46 are clamped to the stationary jaw using the pinch bolt 38.

An oiling hole 26 is drilled and tapped in the cam follower 24. The cam follower 24 is clamped to the rear face of the movable jaw 20 in a jig which dictates its proper position; which would be equidistant from the sides of the movable jaw 20 and a distance from the top which dictates an efficient geometry in the jaw movement. The oiling hole 26 is positioned to be upward. The movable jaw 20 is welded to the cam follower.

The side plates 46, cut to length from flat steel stock, are clamped together for the drilling of pilot holes according to a template. Clamping together ensures perfect alignment between the two side plates 46. The side plates 46 can then be separated for final drilling. The ends of the cam shaft 30 each require a different size hole.

After the various holes have been drilled in the side plates 46 they are once again clamped together with bolts, an alignment mandrel having been first inserted in the holes for the cam shaft 30 ends. The mandrel extends on each side of the assembly to accommodate the cam shaft bushings 50 and the mandrel has a hole through its centre for a bolt with a washer at each end to clamp the bushings to the side plates 46. The cam shaft bushings 50 are welded to the side plates. The welds should stop short of the lubrication holes in the tops of the cam shaft bushings 50, the lubrication holes are not illustrated, for the sake of clarity.

Not shown in the drawings, a sheet metal cover for the cam assembly abuts the movable jaw 20 and wraps an upper segment of the cam follower 24 and is held in place by a screw in the threaded oiling hole 26. A flat sheet metal cover rests atop the rear legs 52, attached with small magnets glued to the tops of the rear legs 52. These covers are not shown in the drawings for the sake of clarity.

Flat steel stock for the front legs is cut to length across the flat at angles which oppose each other. Flat steel stock for the rear legs is cut to length. The holes in the front leg assembly 54 and rear leg assembly 52 are centre punched according to the template used for the side plates 46 to ensure proper alignment and then drilled. A front foot 55 and a rear foot 53 are cut to length from flat steel stock and their ends drilled for the accommodation of hold down bolts.

A reactive stop 36 for the bottom of the movable jaw 20 is cut to length from round steel stock and a groove is cut into each end on a lathe for retaining clips 48.

Two side plates spacers 42 are cut to length from tubular steel stock.

Four nuts and bolts 43 are provided. Two through bolts and nuts 44 for the spacers 42 are provided

One reactive stop and pinch bolt 38 is provided.

A transparent feed opening cover 56 is polycarbonate sheet, cut to size and drilled to receive the posts of magnets 58, the position of the magnets to correspond with the top edges of the side plates 46.

The components are assembled, the crusher assembly is set upon the its front foot 55 and its rear foot 53. The legs are welded to the feet.

### OPERATION

This invention may be operated free standing or bolted to a bench or any stable object.

A transparent feed opening cover 56 is held to the tops of the side plates 46 by magnets 58, with the forward edge abutting the uppermost portion of the face of the stationary jaw 22. The transparent feed opening cover 56 should be removed or hinged to one side or the other, one magnet 58 or the other serving as a hinge.

A first step in operation would be to set the gap between the bottom of the movable jaw 20 and the bottom of the stationary jaw 22, according to the desired finish size of the material after crushing. After slightly slacking the reactive stop pinch bolt 38, the stationary jaw 22 may be adjusted in the vertical plane to achieve the desired gap. The reactive stop pinch bolt 38 is then securely tightened.

Materials to be crushed are deposited in the feed opening; the transparent feed opening cover 56 is then placed over the feed opening.

A readily detachable, conventional square drive lever, serves as the cam shaft 30 driver, and is inserted in the cam shaft driver receiver 34, facilitating the rotation of the cam shaft 30. The cam shaft 30 may be rotated clockwise or counter-clockwise, through any increment of 360 degrees. Rotation of the cam shaft 30 and its cam lobe 28 FIG. 2 in the cam follower 24 operates the movable jaw. Reciprocating movement of the square drive lever cam shaft 30 driver through an arc in either direction will achieve a crushing action.

While the above description contains many specificities, these should not be construed as limitations on the scope of the invention, but rather as an exemplification of one embodiment thereof. Many variations are possible.

Utilizing the conventional square drive system provides a convenient and economic means of driving the cam shaft. Many male to female lever engaging means are possible. An end of the cam shaft could be hexagonal to receive a wrench or formed to receive a socket wrench. Other detachable lever means can be devised, such as a lever which grips the cam shaft.

The vertical stationary jaw need not be vertical.

The reactive stop and pinch bolt need not be of the threaded nut and bolt variety. It could for instance utilize one of a variety of cam lock systems.

The upper ends of the front legs could abut the upper portion of the stationary jaw and the re-active stop pinch bolt be transversely against the lower portion of the stationary jaw.

A length of square steel tube or a length of steel channel could be used for the crusher body.

Accordingly, the scope of the invention should not be determined by the embodiments described, but by the appended claims and their legal equivalents.

What I claim is:

1. I claim a manually operated jaw crusher having a stationary jaw and a movable jaw, wherein said movable jaw can be moved to crush materials entered between said stationary jaw and said movable jaw; said movable jaw being moved by the operation of a cam which is manually operated, said cam being axially adapted to receive in its axis a readily removable lever bar means.

2. I claim the manually operated jaw crusher of claim 1, wherein said stationary jaw is releaseably clamped between side plates by a clamping means, said clamping means is transversely against the rear of said stationary jaw, whereby said clamping means also acts as a reactive member to said stationary jaw.

3. I claim the manually operated jaw crusher of claim 2, wherein a front leg means having upper and lower ends, is attached to said side plates, and the upper end abuts the rear of said stationary jaw, whereby said front leg means act as a reactive member to said stationary jaw.

4. I claim the manually operated jaw crusher of claim 3, wherein a transparent cover for a feed opening has magnets attached, whereby said cover can be attached to the tops of said side plates; said magnets also serve as hinges, whereby said transparent cover can be hinged up from either side, while alternatively be totally removable.

5. I claim a manually operated jaw crusher having a stationary jaw and a movable jaw, wherein said movable jaw is movable to crush materials entered between said stationary jaw and said movable jaw; said movable jaw being moved by the operation of a cam, the shaft of said cam having an axial receiving means for a detachable square drive lever means and said cam being rotatable with said detachable square drive lever means; the ends of said cam being journaled in side plates; said side plates being held separated by means which maintain said side plates in a rigid structure thereby constituting a body for said manually operated jaw crusher, said side plates containing there between, said movable jaw and said stationary jaw, said stationary jaw being releaseably clampable between said side plates by a clamping means, said side plates having front and rear leg means attached thereto.

6. I claim the manually operated jaw crusher of claim 5, wherein said stationary jaw is releaseably clampable between said side plates by a pinch bolt means which passes through said side plates, said pinch bolt means is transversely against the rear of said stationary jaw, whereby said pinch bolt means acts as a reactive member to said stationary jaw.

7. I claim the manually operated jaw crusher of claim 6, wherein said front leg means has an upper and lower end and is attached to said side plates so that the upper end abuts the rear of said stationary jaw, thereby serving as a reactive member to said stationary jaw.

8. I claim the manually operated jaw crusher of claim 7, wherein a transparent cover for a feed opening has magnets attached, whereby said cover can be attached to the tops of said side plates; said magnets also serve as hinges, whereby said transparent cover can be hinged up from either side, while alternatively be totally removable.
